(19) United States
(12) Patent Application Publication
(10) Pub. No.: US 2006/0062227 A1
(43) Pub. Date: Mar. 23, 2006

(54) Switched fabric payload module having an embedded central switching resource

(76) Inventors: Robert C. Tufford, Chandler, AZ (US); Jeffrey M. Harris, Chandler, AZ (US); Douglas L. Sandy, Chandler, AZ (US)

Correspondence Address: MOTOROLA, INC., LAW DEPARTMENT, 1303 E. ALGONQUIN ROAD, SCHAUMBURG, IL, 60196, US

(21) Appl. No.: 10/948,504

(22) Filed: Sep. 23, 2004

(51) Int. Cl. H04L 12/28

(52) U.S. Cl. 370/401

(57) ABSTRACT

A multi-service platform system, includes a backplane (104), a switched fabric (106) on the backplane, and at least one of a VMEbus network and a PCI network coincident with the switched fabric on the backplane. A payload module (102) has one of a 6U form factor and a 9U form factor, where the payload module is communicatively coupled with the backplane using the switched fabric and at least one of the VMEbus network and the PCI network. At least one multi-gigabit connector (118) is coupled to a rear edge (119) of the payload module, where the at least one multi-gigabit connector is coupled to communicatively interface the payload module to the backplane, and where the switched fabric and at least one of the VMEbus network and the PCI network are communicatively coupled with the payload module through the at least one multi-gigabit connector. At least one of a payload subunit (112) and an I/O element (105) are coupled to the payload module. An embedded central switching resource (107) is coupled to the at least one of payload subunit and I/O element, where the embedded central switching resource is coupled to operate the switched fabric with the omission of a dedicated switch module (103), where the embedded central switching resource is coupled to allow the at least one payload subunit and I/O element equal hierarchical access to the switched fabric as a second payload module (109) coupled to the switched fabric.

### BACKGROUND OF THE INVENTION

Expansion cards can be added to computer systems to lend additional functionality or augment capabilities. Current expansion cards interface and communicate with computer systems using primarily a multi-drop parallel bus network architecture, such as Peripheral Component Interconnect (PCI) or VERSAmodule Eurocard (VMEbus). A multi-drop parallel bus architecture has the disadvantage that it can only be used to support one instantaneous communication between modules in a computer system or network. However, some applications have requirements for simultaneous high bandwidth transfers between modules that cannot be handled by the multi-drop parallel bus architecture.

Module real estate and front panel space can be limited. This has the effect of limiting the number of processing and input/output (I/O) elements that can reside on prior art modules.

In the prior art, 6U form factor cards are common. The 9U form factor offers an advantage of placing more computing features on a given card. Prior art 9U form factor expansion cards interface with a backplane using parallel multi-drop networks. This has the disadvantage of being slow and cumbersome for network expansion.

Accordingly, there is a significant need for an apparatus and method that overcomes the deficiencies of the prior art outlined above.

### BRIEF DESCRIPTION OF THE DRAWINGS

Referring to the drawing:

FIG. 1 depicts a multi-service platform system according to one embodiment of the invention.

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENTS

In the following detailed description of exemplary embodiments of the invention, reference is made to the accompanying drawings, which illustrate specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

For clarity of explanation, the embodiments of the present invention are presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

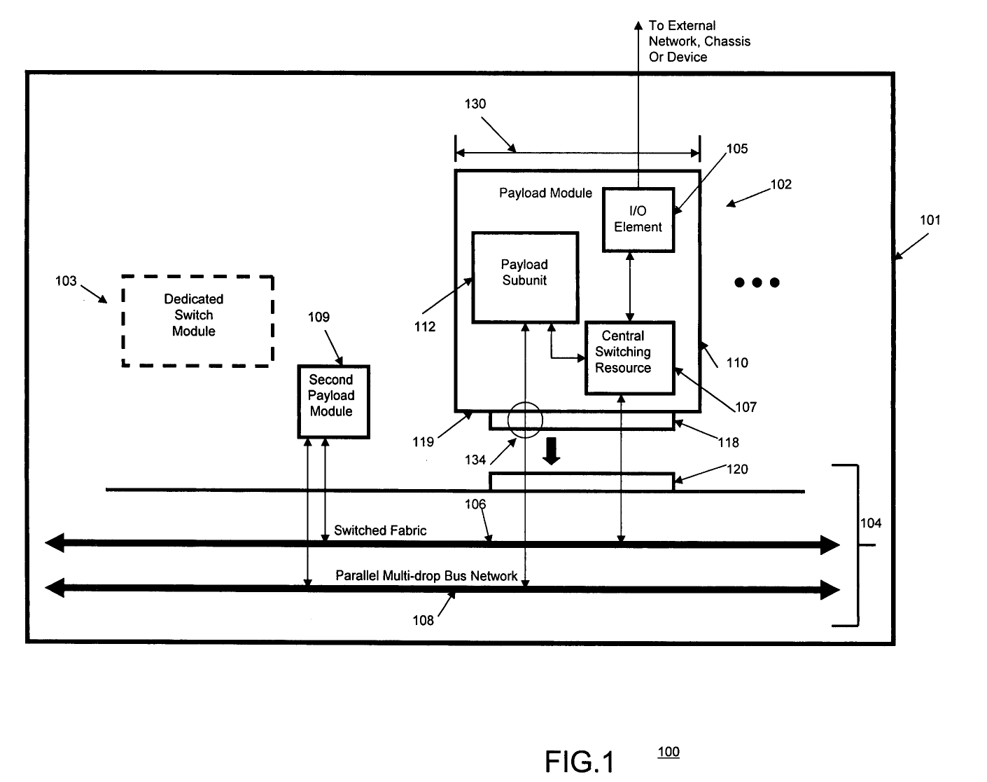

FIG. 1 depicts a multi-service platform system 100 according to one embodiment of the invention. Multi-service platform system 100 can include computer chassis 101, with software and any number of slots for inserting modules, which can be, for example and without limitation, a payload module 102, and the like. Payload module 102 can add functionality to multi-service platform system 100 through the addition of processors, memory, storage devices, device interfaces, network interfaces, and the like. In an embodiment, multi-service platform system 100 can be an embedded, distributed processing computer system, where computer chassis 101 is an embedded computer chassis.

In an embodiment, multi-service platform system 100 can be controlled by a platform controller (not shown for clarity), which can include a processor for processing algorithms stored in memory. Memory comprises control algorithms, and can include, but is not limited to, random access memory (RAM), read only memory (ROM), flash memory, electrically erasable programmable ROM (EEPROM), and the like. Memory can contain stored instructions, tables, data, and the like, to be utilized by processor. Platform controller can be contained in one, or distributed among two or more payload modules with communication among the various modules of multi-service platform system 100.

Multi-service platform system 100 can include backplane 104 coupled for receiving payload module 102. Backplane 104 can include hardware and software necessary to implement a coincident parallel multi-drop bus network 108 and a switched fabric 106. Backplane 104 can include switched fabric 106 and a parallel multi-drop bus network 108. In an embodiment, both switched fabric 106 and parallel multi-drop bus network 108 run concurrently on backplane 104.

In an embodiment, parallel multi-drop bus network 108 can be a VMEbus network. VMEbus network is defined in the ANSI/VITA 1-1994 and ANSI/VITA 1.1-1997 standards, promulgated by the VMEbus International Trade Association (VITA), P.O. Box 19658, Fountain Hills, Ariz., 85269 (where ANSI stands for American National Standards Institute). In an embodiment of the invention, VMEbus network can include VMEbus based protocols such as Single Cycle Transfer protocol (SCT), Block Transfer protocol (BLT), Multiplexed Block Transfer protocol (MBLT), Two Edge VMEbus protocol (2 eVME) and Two Edge Source Synchronous Transfer protocol (2eSST). VMEbus network 108 is not limited to the use of these VMEbus based protocols and other VMEbus based protocols are within the scope of the invention.

In another embodiment, parallel multi-drop bus network 108 can be a Peripheral Component Interconnect (PCI) network. PCI network can include standard PCI or Peripheral Component Interconnect-X (PCI-X) based protocols. Examples of variants of PCI-X protocols, without limitation, include 133 MHz 64-bit PCI-X, 100 MHz 64-bit PCI-X down to 66 MHz 32-bit PCI-X, and the like. Examples of PCI based protocols (a subset of PCI-X based protocols), can include 66 MHz 64-bit PCI down to 33 MHz 32-bit PCI, and the like.

Switched fabric 106 can use an embedded central switching resource 107 as a hub to operate switched fabric 106. In an embodiment, embedded central switching resource 107 is located on payload module 102. In the prior art, embedded central switching resource was located on a dedicated switch module 103. Dedicated switch module 103 was a separate module placed in a separate slot of a computer chassis that was dedicated exclusively to operating switched fabric. Dedicated switch module 103 contained one or more central switching resources to operate one or more switched fabrics. This had the disadvantage of using scarce slots in a computer chassis and relegating elements on payload modules to unequal hierarchical access to switched fabric as compared to other payload modules coupled to switched fabric.

In an embodiment, embedded central switching resource 107 can be coupled to any number of payload modules 102. Switched fabric 106 can be based on a point-to-point, switched input/output (I/O) fabric, whereby cascaded switch devices interconnect end node devices. Although FIG. 1 depicts switched fabric 106 as a bus for diagrammatic ease, switched fabric 106 may in fact be a star topology, mesh topology, and the like as known in the art for communicatively coupling modules. Switched fabric 106 can include both module-to-module (for example computer systems that support I/O module add-in slots) and chassis-to-chassis environments (for example interconnecting computers, external storage systems, external Local Area Network (LAN) and Wide Area Network (WAN) access devices in a data-center environment). Switched fabric 106 can be implemented by using one or more of a plurality of switched fabric network standards, for example and without limitation, InfiniBand™, Serial RapidIO™, FibreChannel™, Ethernet™, PCI Express™, Hypertransport™, and the like. Switched fabric 106 is not limited to the use of these switched fabric network standards and the use of any switched fabric network standard is within the scope of the invention.

In an embodiment of the invention, parallel multi-drop bus network 108 and switched fabric 106 operate concurrently within multi-service platform system 100. In an example of an embodiment, parallel multi-drop bus network 108 can operate as a control plane by synchronizing and organizing activities in multi-service platform system 100. Switched fabric 106 can operate as a data plane by transferring data between individual payload modules 102. In this embodiment, data is transferred faster through the higher bandwidth switched fabric 106, while the parallel multi-drop bus network 108 controls and manages the overall system. This has the effect of increasing the speed of multi-service platform system 100 since data transfers that are in excess of parallel multi-drop bus network 108 bandwidth can take place using switched fabric 106. In an embodiment, payload module 102 is communicatively coupled with backplane 104 using switched fabric 106 and at least one of VMEbus network or PCI network (parallel multi-drop bus network 108).

Multi-service platform system 100 can include any number of payload modules 102 coupled to backplane 104. Backplane 104 can include hardware and software necessary to implement a coincident parallel multi-drop bus network 108 and a switched fabric 106.

In an embodiment, payload module 102 can comprise a board 110, for example a printed wire board (PWB), and the like. Coupled to the board 110 can be one or more payload subunits 112. In an embodiment, payload subunit 112 can include any combination of processor, memory, storage, communication devices and the like. Payload subunit can add computational functionality to multi-service platform system 100. For example, payload subunit 112 can add any type of computing, storage, communication features, and the like, to multi-service platform system 100. In an embodiment, payload module 102 can have a form factor 130, which can refer to physical dimensions, electrical connections, and the like, of payload module 102. In an embodiment, payload module 102 can have one of a 6U form factor or a 9U form factor.

As is known in the art, “U” and multiples of “U” can refer to the width of a module or expansion card. In an embodiment, “U” can measure approximately 1.75 inches. Payload module 102 can have its own specific set of electrical connections to interface with backplane 104 of computer chassis 101. As an example of an embodiment, multi-service platform system 100 can include computer chassis 101 and one or more payload modules 102, each having one of a 6U form factor or a 9U form factor. In an embodiment, such payload modules 102 can conform to the VITA 46 standard as set forth by VMEbus International Trade Association (VITA), P.O. Box 19658, Fountain Hills, Ariz., 85269.

In an embodiment, backplane 104 and payload module 102 can have a set of interlocking, modular connectors designed to interlock with each other when payload module 102 is placed in a slot of multi-service platform system 100. In the embodiment shown, payload module 102 has at least one multi-gigabit connector 118 coupled to rear edge 119. In an embodiment, at least one multi-gigabit connector 118 can include printed circuit board (PCB) wafers (as opposed to metal pins), where wafers are held together in a plastic housing and can be coupled to the payload module 102 using press to fit contacts. For example, at least one multi-gigabit connector 118 can use PCB based pinless interconnect that uses printed circuit wafers instead of traditional pin and socket contacts.

In an embodiment, at least one multi-gigabit connector 118 can use at least one of single ended or differential pair 134 signal configuration in the same connector. Multi-gigabit connector 118 can transfer data in excess of three (3) gigabits per second per each differential pair 134. In an embodiment, differential pair 134 can be a bonded differential pair. At least one multi-gigabit connector 118 is coupled to communicatively interface payload module 102 with backplane 104, where switched fabric 106 and at least one of VMEbus network or PCI network are communicatively coupled to payload module 102 through at least one multi-gigabit connector 118.

In an embodiment, at least one multi-gigabit connector 118 is coupled to interface with at least one corresponding multi-gigabit connector 120 on backplane 104. At least one corresponding multi-gigabit connector 120 can be a female receptacle with metal beam spring leaf contacts which engage with the PCB wafers of multi-gigabit connector 118 when coupled together.

In an embodiment, at least one multi-gigabit connector 118 spans substantially the entire portion of the rear edge 119 of payload module 102. Rear edge 119 can include any number of multi-gigabit connectors 118 and be within the scope of the invention. In an embodiment, all communication between payload module 102 and backplane 104 occur exclusively through at least one multi-gigabit connector 118. In this embodiment, rear edge 119 of payload module 102 excludes a legacy connector, which can include traditional pin and socket connectors designed for low-speed data transfer. In other words, all data transfer and communication, whether to/from switched fabric 106 and at least one of VMEbus network or PCI network (parallel multi-drop bus network 108) occur through at least one multi-gigabit connector 118.

In an example of an embodiment of the invention, at least one multi-gigabit connector 118 and corresponding at least one multi-gigabit connector 120 can be a Tyco MultiGig RT connector manufactured by the AMP division of Tyco Electronics, Harrisburg, Pa. The invention is not limited to the use of the Tyco MultiGig RT connector, and any connector capable of throughput per differential pair of at least three gigabits per second is encompassed within the invention.

In addition to at least one payload subunit 112, payload module 102 can comprises at least one input/output (I/O) element 105. In an embodiment, at least one I/O element 105 can include any mechanical, electrical, optical, and the like means to couple payload module to any external network, external chassis or external device. For example, I/O element 105 can include, without limitation, ports, modems, infra-red port, wireless means, and the like, that function to interface payload module 102 to any of external network, external chassis or external device.

As described above, payload module can include an embedded central switching resource 107 coupled to the at least one of payload subunit and I/O element. In an embodiment, embedded central switching resource 107 is coupled to operate switched fabric 106 with the omission of a dedicated switch module 103 in multi-service platform system 100. Embedded central switching resource 107 is coupled to allow the at least one payload subunit 112 and I/O element 105 equal hierarchical access to the switched fabric as a second payload module 109 coupled to the switched fabric 106. This embodiment has the advantage of omitting dedicated switch module 103 from multi-service platform system 100. This frees up a slot in computer chassis 101 for other uses and provides more efficient access to switched fabric for payload subunit 112 and I/O element 105.

In an embodiment, equal hierarchical access can mean that at least one payload subunit 112 and I/O element 105 are at the same level in a connection hierarchy from embedded central switching resource 107 as second payload module 109. As an example, both second payload module 109 and payload subunit 112 both directly coupled to embedded central switching resource 107 includes payload subunit 112 and second payload module 109 being at the same hierarchical level.

In an embodiment, other elements can be interposed between I/O element 105 and external network, external chassis or external device. For example, a bridging module can be interposed to bridge to/from a switched fabric network standard to a different communication standard, for example and without limitation, Small Computer System Interface (SCSI), IDE, AT Attachment (ATA), RS232, PS/2, and the like.

While we have shown and described specific embodiments of the present invention, further modifications and improvements will occur to those skilled in the art. It is therefore, to be understood that appended claims are intended to cover all such modifications and changes as fall within the true spirit and scope of the invention.

1. A multi-service platform system having a backplane integrated with a computer chassis, the multi-service platform system comprising:
a switched fabric on the backplane;
at least one of a VMEbus network and a PCI network coincident with the switched fabric on the backplane;
a payload module having one of a 6U form factor and a 9U form factor, wherein the payload module is communicatively coupled with the backplane using the switched fabric and at least one of the VMEbus network and the PCI network;
at least one multi-gigabit connector coupled to a rear edge of the payload module, wherein the at least one multi-gigabit connector is coupled to communicatively interface the payload module to the backplane, and wherein the switched fabric and at least one of the VMEbus network and the PCI network are communicatively coupled with the payload module through the at least one multi-gigabit connector;
at least one of a payload subunit and an I/O element coupled to the payload module; and
an embedded central switching resource coupled to the at least one of payload subunit and I/O element, wherein the embedded central switching resource is coupled to operate the switched fabric with omission of a dedicated switch module in multi-service platform system, wherein the embedded central switching resource is coupled to allow the at least one payload subunit and I/O element equal hierarchical access to the switched fabric as a second payload module coupled to the switched fabric.

2. The multi-service platform system of claim 1, wherein the at least one payload subunit is coupled to provided computational functionality to multi-service platform system.

3. The multi-service platform system of claim 1, wherein the I/O element is coupled to provide connectivity to at least one of external network, external chassis and external device.

4. The multi-service platform system of claim 1, wherein communication between the backplane and the payload module occur exclusively through the at least one multi-gigabit connector.

5. The multi-service platform system of claim 1, wherein the at least one multi-gigabit connector spans substantially an entire portion of the rear edge of the payload module.

6. The multi-service platform system of claim 1, wherein the at least one multi-gigabit connector is coupled to interface with at least one corresponding multi-gigabit connector on the backplane.

7. A computer chassis, comprising:
a backplane integrated in the computer chassis;
a switched fabric on the backplane;
at least one of a VMEbus network and a PCI network coincident with the switched fabric on the backplane;
a payload module having one of a 6U form factor and a 9U form factor, wherein the payload module is communicatively coupled with the backplane using the switched fabric and at least one of the VMEbus network and the PCI network;
at least one multi-gigabit connector coupled to a rear edge of the payload module, wherein the at least one multi-gigabit connector is coupled to communicatively interface the payload module to the backplane, and wherein the switched fabric and at least one of the VMEbus network and the PCI network are communicatively coupled with the payload module through the at least one multi-gigabit connector;
at least one of a payload subunit and an I/O element coupled to the payload module; and
an embedded central switching resource coupled to the at least one of payload subunit and I/O element, wherein the embedded central switching resource is coupled to operate the switched fabric with omission of a dedicated switch module in multi-service platform system, wherein the embedded central switching resource is coupled to allow the at least one payload subunit and I/O element equal hierarchical access to the switched fabric as a second payload module coupled to the switched fabric.

8. The computer chassis of claim 7, wherein the at least one payload subunit is coupled to provided computational functionality to multi-service platform system.

9. The computer chassis of claim 7, wherein the I/O element is coupled to provide connectivity to at least one of external network, external chassis and external device.

10. The computer chassis of claim 7, wherein communication between the backplane and the payload module occur exclusively through the at least one multi-gigabit connector.

11. The computer chassis of claim 7, wherein the at least one multi-gigabit connector spans substantially an entire portion of the rear edge of the payload module.

12. The computer chassis of claim 7, wherein the at least one multi-gigabit connector is coupled to interface with at least one corresponding multi-gigabit connector on the backplane.

13. A payload module, comprising:
a payload subunit coupled to the payload module, wherein the payload module has one of a 6U form factor and a 9U form factor;
at least one multi-gigabit connector coupled to a rear edge of the payload module and to the payload subunit, wherein the at least one multi-gigabit connector is coupled to communicatively interface the payload subunit to a backplane, wherein the backplane includes a switched fabric coincident with at least one of a VMEbus network and a PCI network, and wherein the switched fabric and at least one of the VMEbus network and the PCI network are communicatively coupled to the payload subunit through the at least one multi-gigabit connector;
at least one of a payload subunit and an I/O element coupled to the payload module; and
an embedded central switching resource coupled to the at least one of payload subunit and I/O element, wherein the embedded central switching resource is coupled to operate the switched fabric with omission of a dedicated switch module in multi-service platform system, wherein the embedded central switching resource is coupled to allow the at least one payload subunit and I/O element equal hierarchical access to the switched fabric as a second payload module coupled to the switched fabric.

14. The payload module of claim 13, wherein the at least one payload subunit is coupled to provided computational functionality to multi-service platform system.

15. The payload module of claim 13, wherein the I/O element is coupled to provide connectivity to at least one of external network, external chassis and external device.

16. The payload module of claim 13, wherein communication between the backplane and the payload module occur exclusively through the at least one multi-gigabit connector.

17. The payload module of claim 13, wherein the at least one multi-gigabit connector spans substantially an entire portion of the rear edge of the payload module.

18. The payload module of claim 13, wherein the at least one multi-gigabit connector is coupled to interface with at least one corresponding multi-gigabit connector on the backplane.

19. A method, comprising:
providing a payload module coupled to a backplane, wherein the payload module has one of a 6U form factor and a 9U form factor;
providing at least one multi-gigabit connector directly coupled to a rear edge of the payload module, wherein the at least one multi-gigabit connector is coupled to communicatively interface the payload module to a backplane, wherein the backplane includes a switched fabric coincident with at least one of a VMEbus network and a PCI network, and wherein the switched fabric and at least one of the VMEbus network and the PCI network are communicatively coupled to the payload module through the at least one multi-gigabit connector;
at least one of a payload subunit and an I/O element coupled to the payload module; and
an embedded central switching resource coupled to the at least one of payload subunit and I/O element operating the switched fabric with omission of a dedicated switch module in multi-service platform system, wherein the embedded central switching resource is coupled to allow the at least one payload subunit and I/O element equal hierarchical access to the switched fabric as a second payload module coupled to the switched fabric.

20. The method of claim 19, further comprising the at least one payload subunit providing computational functionality to multi-service platform system.

21. The method of claim 19, further comprising the I/O element providing connectivity to at least one of external network, external chassis and external device.

22. The method of claim 19, wherein communication between the backplane and the payload module occur exclusively through the at least one multi-gigabit connector.

23. The method of claim 19, wherein the at least one multi-gigabit connector spanning substantially an entire portion of the rear edge of the payload module.

24. The method of claim 19, wherein the at least one multi-gigabit connector is coupled to interface with at least one corresponding multi-gigabit connector on the backplane.
